(19) United States
(12) Patent Application Publication
(10) Pub. No.: US 2026/0197567 A1
(43) Pub. Date: Jul. 9, 2026

(54) PROVISIONING OF NETWORK SERVICES VIA PASSIVE OPTICAL NETWORK PORTS THAT HAVE BEEN INCORRECTLY CONNECTED OR ASSIGNED

(71) Applicant: Level 3 Communications, LLC, Denver, CO (US)

(72) Inventors: William Gray, Boulder, CO (US); Ryan Duhon, Salt Lake City, UT (US); Kevin Lu, Bridgewater, NJ (US)

(73) Assignee: Level 3 Communications, LLC, Denver, CO (US)

(21) Appl. No.: 19/303,712

(22) Filed: Aug. 19, 2025

Related U.S. Application Data
(60) Provisional application No. 63/742,728, filed on Jan. 7, 2025.

(51) Int. Cl. H04Q 11/00

(52) U.S. Cl. CPC H04Q 11/0067; H04Q 2011/0079

(57) ABSTRACT

Novel tools and techniques are provided for implementing provisioning of network services via passive optical network (“PON”) ports that have been incorrectly assigned or connected. In response to receiving an indication that a first port, of a PON terminal, to which a first customer premises equipment (“CPE”) at a first customer premises has been assigned to be connected is already being used to connect a second CPE at a second customer premises, a computing system may identify a second port that is available to provide network services, may autonomously cause re-assignment of the first CPE from the first port to the second port, within a service provider database, may autonomously cause updating of network configurations of the first CPE to enable provisioning of network services over the second port, and may autonomously cause provisioning of network services to the first CPE via the second port, based on the re-assignment.

### CROSS-REFERENCES TO RELATED APPLICATIONS

This application claims priority to U.S. patent application Ser. No. 63/742,728 (the “'728 Application”), filed Jan. 7, 2025, by William Gray et al., entitled, “Provisioning of Network Services Via Passive Optical Network Ports That Have Been Incorrectly Connected or Assigned,” the disclosure of which is incorporated herein by reference in its entirety for all purposes.

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing provisioning of network services, and, more particularly, to methods, systems, and apparatuses for implementing provisioning of network services via passive optical network ports that have been incorrectly assigned or connected.

### BACKGROUND

When provisioning network services over a passive optical network (“PON”) to a plurality of customer premises equipment (“CPE”) that is located at a corresponding plurality of customer premises locations, optical fiber connectors at PON terminals (e.g., at optical line terminals (“OLTs”) and/or at multiport service terminals (“MSTs”), etc.) for some CPE among the plurality of CPE may be connected to incorrect ports based on assignments of ports to CPE. In cases that network services are provisioned to these CPE despite the incorrect port connections and without correcting the assignments of the ports to the connected CPE, inventory of network resources (including ports and network connections, etc.) would be made incorrect, resulting in future disruptions or future network connectivity issues (e.g., failure to connect, failure to activate, etc.) for provisioning network services to other CPE among the plurality of CPE. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing provisioning of network services via passive optical network ports that have been incorrectly assigned or connected, in accordance with various embodiments.

FIG. 2A depicts an example system illustrating communication exchanges when implementing provisioning of network services via passive optical network ports that have been incorrectly assigned or connected, in accordance with various embodiments.

FIG. 2B depicts another example system illustrating communication exchanges when implementing provisioning of network services via passive optical network ports where there has been a change in residents at a customer premises location, in accordance with various embodiments.

FIG. 3 depicts flow diagrams illustrating a method for implementing provisioning of network services via passive optical network ports, where a port that has been assigned to one CPE is already being used to connect another CPE, in accordance with various embodiments.

FIG. 4 depicts flow diagrams illustrating another method for implementing provisioning of network services via passive optical network ports, where there has been a change in residents at a customer premises location, in accordance with various embodiments.

FIG. 5 depicts flow diagrams illustrating yet another method for implementing provisioning of network services via passive optical network ports, where an identifier (“ID”) of CPE that is connected to a port is inconsistent with an ID of another CPE that has been assigned to be connected to that port, in accordance with various embodiments.

FIG. 6 depicts a block diagram illustrating an exemplary computer or system hardware architecture, in accordance with various embodiments.

### DETAILED DESCRIPTION OF CERTAIN EMBODIMENTS

### Overview

As briefly discussed above, incorrectly assigned or connected PON terminal ports for some CPE among a plurality of CPE may cause inventory of network resources (including ports and network connections, etc.) to be made incorrect, resulting in future disruptions or future network connectivity issues (e.g., failure to connect, failure to activate, etc.) for provisioning network services to other CPE among the plurality of CPE.

The present technology provides for provisioning of network services via passive optical network ports that have been incorrectly assigned or connected. In some examples, when a first CPE (e.g., an optical network terminal (“ONT”), a residential gateway (“RG”), a combination ONT/RG network interface device (e.g., “smart network interface device” or “SmartNID”), etc.) is assigned to be connected to a first port of a PON terminal (e.g., OLT or MST), but the first port is already being used to connect a second CPE, the system, as described herein, may identify a second port over which network service can be provided to the first CPE, may re-assign the first CPE to the second port, may update network configurations of the first CPE accordingly, then may provision network services to the first CPE over the second port.

In another example, after a second entity has moved into a customer premises location, and is trying to obtain network services over a third CPE that remains at the customer premises location (and remains connected to a third port of the PON terminal) and that was previously assigned to a first entity who has left and is no longer associated with either the third CPE or the customer premises location (in some cases, with network services either still being associated with the first entity and thus unavailable to the second entity, or network services to the third CPE being terminated), the system may re-assign the third CPE and the third port to which the third CPE is connected, may update network configurations of the third CPE accordingly, then may provision network services, via the third CPE, to the third CPE and to a device(s), which is associated with the second entity and is disposed at the customer premises location.

In yet another example, after a fourth CPE connects to the network via a fourth port of the PON terminal, the system performs a handshake operation and/or an authentication operation with the fourth CPE, but the system does not recognize an ID of the fourth CPE as corresponding to the fourth port. After authentication, the system may verify that network services are authorized to be provisioned to the fourth CPE over a fifth port, may re-assign the fourth CPE from a fifth port to the fourth port, may update network configurations of the fourth CPE to enable provisioning of network services to the fourth CPE via the fourth port of the PON terminal, based on the re-assignment of the fourth CPE.

In the manner as described above with respect to each of the examples, CPE may be provisioned with network services despite being connected to an incorrectly assigned or incorrectly connected port of the PON terminal, by correcting, updating, or re-assigning assignments of ports to CPE and by updating network configurations of the CPE with updated network configurations based on the re-assignment. Accordingly, correct assignments of the ports to the connected CPE may be achieved, resulting in an accurate inventory of network resources (including ports and network connections, etc.) and avoiding future disruptions or future network connectivity issues (e.g., avoiding failure to connect, avoiding failure to activate, etc.) for provisioning network services to other CPE among the plurality of CPE.

These and other aspects of the provisioning of network services via passive optical network ports that have been incorrectly assigned or connected are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including: receiving, by a computing system, an indication that a first port, among a plurality of ports of a PON terminal, to which a first CPE has been assigned to be connected is already being used to connect, and to provide network service to, a second CPE, the first CPE being located at a first customer premises location and the second CPE being located at a second customer premises location; identifying, by the computing system, a second port among the plurality of ports of the PON terminal that is available to provide network services; autonomously causing, by the computing system, re-assignment of the first CPE from the first port to the second port, within a service provider database; autonomously causing, by the computing system, updating of network configurations of the first CPE to enable provisioning of network services over the second port of the PON terminal; and autonomously causing, by the computing system, provisioning of network services to the first CPE via the second port of the PON terminal, based on the re-assignment of the first CPE from the first port to the second port, within the service provider database.

In another aspect, the technology relates to a system, including a computing system, including a processing system and memory coupled to the processing system. The memory includes computer executable instructions that, when executed by the processing system, causes the computing system to perform operations including receiving, from one or more devices located at a first customer premises location that are associated with a second entity, a request to receive network services over a first CPE that has been connected to a first port, among a plurality of ports of a PON terminal; receiving an indication that a first ID of the first CPE that has been connected to the first port is assigned to a first entity who is no longer associated with the first customer premises location at which the first CPE is located, instead of being assigned to the second entity who is currently associated with the first customer premises location; authenticating the second entity, and verifying whether network services are authorized to be provisioned to the one or more devices located at the first customer premises location that are associated with the second entity; after authenticating the second entity and verifying that network services are authorized to be provisioned to the one or more devices located at the first customer premises location that are associated with the second entity, autonomously causing re-assignment of the first CPE from the first entity to the second entity, within a service provider database; autonomously causing updating of network configurations of the first CPE to enable provisioning of network services that are authorized to be provisioned to the one or more devices over the first port of the PON terminal; and autonomously causing, by the computing system, provisioning of network services to the one or more devices associated with the second entity at the first customer premises location, via the first CPE and via the first port of the PON terminal, based on the re-assignment of the first CPE from the first entity to the second entity, within the service provider database.

In yet another aspect, the technology relates to a method, including receiving, by a computing system, an indication that a first ID of a first CPE that has been connected to a first port, among a plurality of ports of a PON terminal, is inconsistent with a second ID of a second CPE that has been assigned to be connected to the first port, the first CPE being located at a first customer premises location; authenticating, by the computing system, the first CPE based on the first ID, and verifying, by the computing system, whether network services are authorized to be provisioned to the first CPE over a second port among the plurality of ports of the PON terminal; after authenticating the first CPE and verifying that network services are authorized to be provisioned to the first CPE over the second port, autonomously causing, by the computing system, re-assignment of the first CPE from the second port to the first port, within a service provider database; autonomously causing, by the computing system, updating of network configurations of the first CPE to enable provisioning of network services over the first port of the PON terminal; and autonomously causing, by the computing system, provisioning of network services to the first CPE via the first port of the PON terminal, based on the re-assignment of the first CPE from the second port to the first port, within the service provider database.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

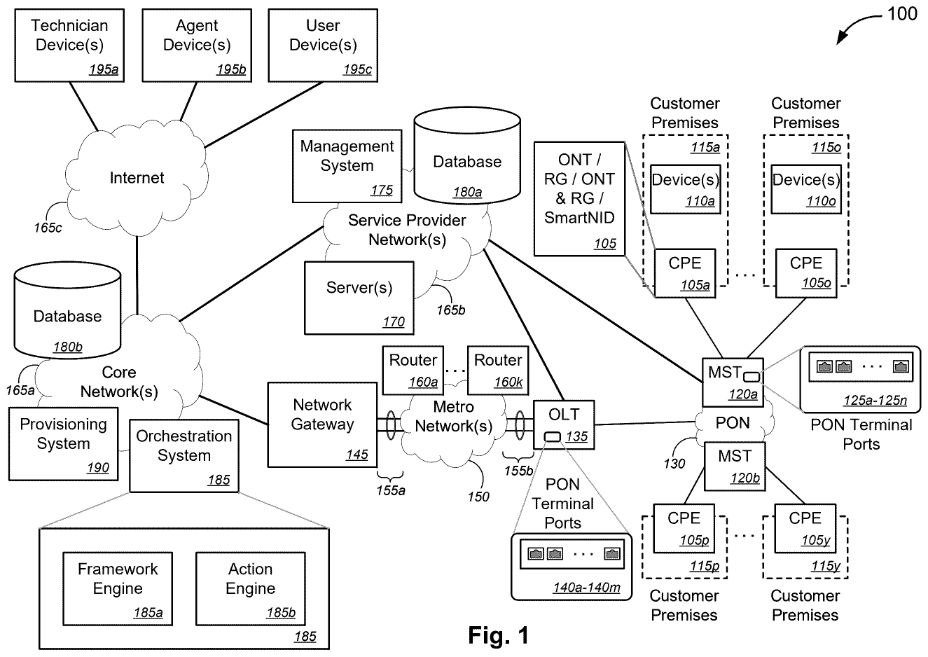

Turning to the embodiments as illustrated by the drawings, FIG. 1-6 illustrate some of the features of methods, systems, and apparatuses for implementing provisioning of network services, and, more particularly, to methods, systems, and apparatuses for implementing provisioning of network services via passive optical network ports that have been incorrectly assigned or connected, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 depicts an example system 100 for implementing provisioning of network services via passive optical network ports that have been incorrectly assigned or connected, in accordance with various embodiments.

In examples, system 100 may include a plurality of CPE 105a-105o and 105p-105y (collectively, “CPE 105” or the like), each of which may include one of an ONT, an RG, one of a plurality of pairs of ONTs and RGs (collectively, “ONTs/RGs” or the like), or a combination ONT/RG network interface device (e.g., a SmartNID, or the like) (collectively, “ONT/RG/ONT and RG/SmartNID 105”). In some examples, system 100 may further include devices 110a-110o and/or 110p-110y, each of which, if present, is located or disposed within a corresponding one of the plurality of customer premises 115a-115o and 115p-115y (collectively, “customer premises 115” or the like). In examples, each of the plurality of CPE 105a-105o and 105p-105y is located or disposed within a corresponding one of the plurality of customer premises 115a-115o and 115p-115y. System 100 may further include one or more MSTs 120a and/or 120b each including a plurality of PON terminal ports 125a-125n, a PON(s) 130, an OLT 135 including a plurality of PON terminal ports 140a-140m, a network gateway 145, a plurality of metro networks 150 (collectively, “metro networks 150” or the like), a plurality of link aggregation groups (“LAGs”) 155a and 155b (collectively, “LAGs 155” or the like; each LAG being denoted by parallel lines bundled by a ring shape), and a plurality of routers 160a-160k (collectively, “routers 160s” or the like). Herein, k, m, n, o, p, and y are non-negative integer numbers that may be either all the same as each other, all different from each other, or some combination of same and different (e.g., one set of two or more having the same values with the others having different values, a plurality of sets of two or more having the same value with the others having different values, etc.).

System 100 may further include a core network(s) 165a, a service provider network(s) 165b, and the Internet 165c. In examples, the system 100 may further include at least one of a server(s) 170, a management system 175, a records system/database 180a and/or 180b, an orchestration system 185, and/or a provisioning system or network provisioning system 190, and/or the like. In some cases, the records system/database 180b, the orchestration system 185, and the provisioning system 190 may be disposed within the core network(s) 165a, while the server(s) 170, the management system 175, and the records system/database 180a may be disposed within service provider network(s) 165b. In other cases, the core network(s) 165a and the service provider network(s) 165b may be implemented as one or more networks 165 that are owned, managed, and/or operated by a service provider, and one or more of the server(s) 170, the management system 175, the records system/database 180a and/or 180b, the orchestration system 185, and/or the provisioning system 190 may be disposed within the one or more networks 165 (in some cases, distributed throughout the one or more networks 165, while in other cases disposed within one or more servers, within one or more data centers, that form nodes of the one or more networks 165).

In some examples, each of at least some of the plurality of CPE 105a-105o and 105p-105y is communicatively coupled with OLT 135 via MST 120a or 120b and via PON 130, by communicatively connecting with one of PON terminal ports 125a-125n of MST 120a or 120b and/or one of PON terminal ports 140a-140m of OLT 135. Each of the PON terminal ports 125a-125n of MST 120a or 120b and/or each of the PON terminal ports 140a-140m of OLT 135 communicatively couples with a computing system in the core network(s) 165a and/or the service provider network(s) 165b via MST 120a/120b and/or OLT 135, via metro network(s) 150 (via LAGs 155a and 155b, and via routers 160a-160k). In examples, the computing system may include one of server(s) 170, management system 175, records system/database 180a and/or 180b, orchestration system 185, framework engine 185a of the orchestration system 185, action engine 185b of the orchestration system 185, and/or provisioning system 190, and/or the like.

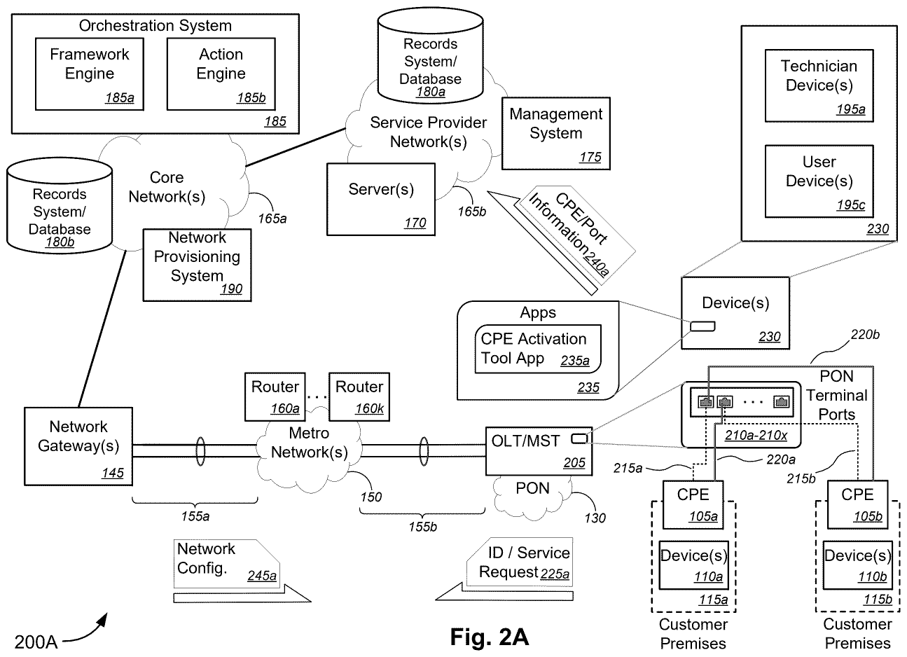

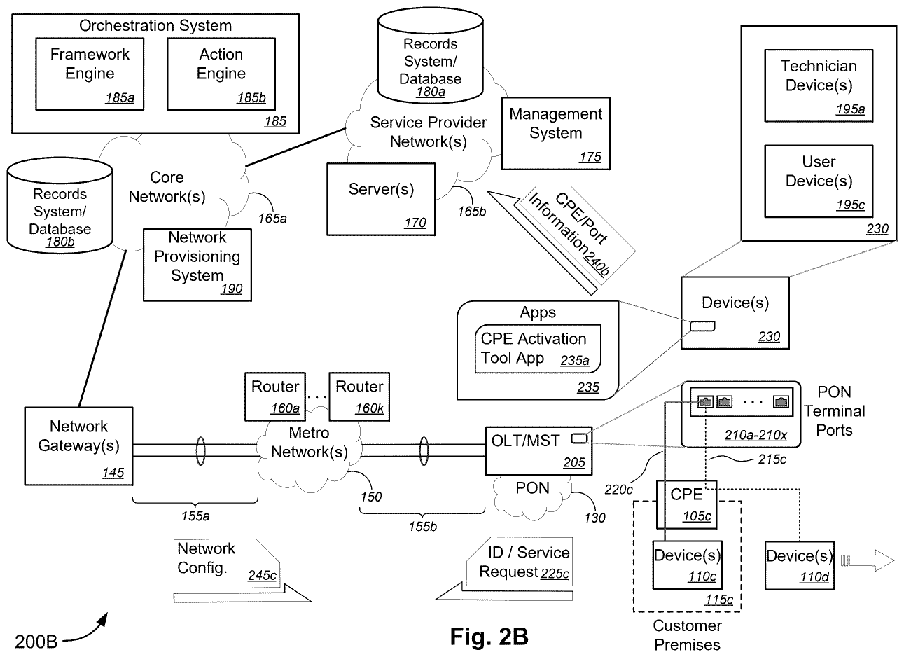

In examples, framework engine 185a identifies a current and/or predicted issue(s) associated with at least one of one or more CPE, one or more network services, one or more network equipment, one or more PON terminal ports 125 and/or 140 (or assignment thereof), based on analysis of the network data, management data, CPE-provided data, technician-provided data, agent-provided data, and/or customer-provided data, in some cases, using an artificial intelligence (“AI”) system to identify patterns, characteristics, and/or trends corresponding to the current and/or predicted issue(s). In some instances, actions engine 185b determines one or more next best actions (“NBAs”) to resolve the current and/or predicted issue(s), in some cases, using the AI system. In some examples, the framework engine 185a causes an automation workflow engine of the orchestration system 185 to perform at least one automation workflow as part of the one or more NBAs. If the current and/or predicted issue(s) has not been resolved, the framework engine 185a generates and sends a message to a device(s) 195 indicating an unresolved issue(s) including relevant information and the one or more NBAs. If the current and/or predicted issue(s) has been resolved, the framework engine 185a generates and sends another message to the device(s) 195 indicating that the current and/or predicted issue(s) has been resolved. As described in detail below with respect to FIGS. 2A-5, one issue is the connection of a CPE to an incorrect port as compared with port assignment information as stored in records systems of the service provider, where resolution may involve re-assignment of the CPE to currently connected PON terminal port and/or to another available PON terminal port (as well as providing the CPE with updated network configurations to enable connection via the re-assigned PON terminal port, particularly in the case that the CPE is having connectivity and/or network service issues via the currently connected port). Another issue is when a new customer moves into a customer premises location, but the records system still indicates that the CPE is assigned to the previous customer at that customer premises location, where resolution may involve re-assignment of the CPE at the customer premises location from the previous customer to the new customer (as well as providing the re-assigned CPE with updated network configurations to enable connection via the PON terminal port, particularly in the case that the CPE is having connectivity and/or network service issues for the new customer).

In some examples, MST 120a/120b and/or OLT 135 may communicatively couple with at least one of server(s) 170, management system 175, and/or records system/database 180a in service provider network(s) 165b via a management network channel or connection, rather than a regular data traffic connection through the metro network(s) 150 and network gateway 145. In examples, system 100 may further include one or more devices 195 that communicatively couple with at least one of a server(s) 170, a management system 175, a records system/database 180a and/or 180b, an orchestration system 185, and/or a network provisioning system 190, and/or the like, via one or more of core network(s) 165a, service provider network(s) 165b, and/or Internet 165c. In examples, the one or more devices 195 may include at least one of a technician device(s) 195a associated with a field technician, an agent device(s) 195b associated with an agent of the service provider, and/or a user device(s) 195c associated with an entity or customer who is associated with (or who is assigned) one of the plurality of CPE 105a-105o and 105p-105y. In some instances, the user device(s) may each include one of a desktop computer, a laptop computer, a tablet computer, a smart phone, a mobile phone, or any suitable user device, or the like.

In some cases, customer premises 115a-115o and 115p-115y may each include, but is not limited to, one of a single-family residential customer premises, a multiple dwelling unit (“MDU”) residential customer premises, a business customer premises, a corporate customer premises, an enterprise customer premises, an education facility customer premises, a medical facility customer premises, or a governmental customer premises, and/or the like. In some instances, entities or customers associated with the customer premises 115a-115o and 115p-115y, and/or associated with corresponding ones of the plurality of CPE 105a-105o and 105p-105y may each include, without limitation, one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like.

In examples, PON 130 is a fiber-optic telecommunications network that uses unpowered devices to carry optical signals, and is typically used for the last mile between the customer premises 115 and the service provider network(s) (in this case, metro network(s) 150, core network(s) 165a, service provider network(s) 165b, etc.) and components therein (including network gateway 145, routers 160a-160k, server(s) 170, management system 175, records system/database 180a and/or 180b, orchestration system 185, and/or provisioning system 190, and/or the like). The OLT 135 is configured to provide first optical data signals for transmission over the PON 130 and MST 120 (and corresponding PON terminal port 125) to a plurality of CPE 105 located at customer premises 115 serviced by that PON 130, and configured to relay second optical data signals from the plurality of CPE 105 to the core network(s) 165a, the service provider network(s) 165b, and/or Internet 165c, or to convert the second optical data signals into first electrical data signals for transmission to the network(s) 165a-165c. Each CPE 105 is configured to convert the first optical data signals into second electrical data signals for communication with devices (in some cases, via radio transmission using communication protocols such as Bluetooth™, Wi-Fi, etc.) within the corresponding customer premises 115 that are communicatively coupled with that CPE 105, and configured to convert third electrical data signals received from the devices (in some cases, via electrical transmission or via radio transmission) into the second optical data signals for transmission to a corresponding OLT 135 via the corresponding PON 130 and MST 120 (and corresponding PON terminal port 125).

According to some embodiments, unless otherwise indicated, network(s) 165a-165c may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, unless otherwise indicated, the network(s) 165a-165c may include an access network of the service provider (e.g., an Internet service provider (“ISP”)). In another embodiment, unless otherwise indicated, the network(s) 165a-165c may include a core network of the service provider and/or the Internet.

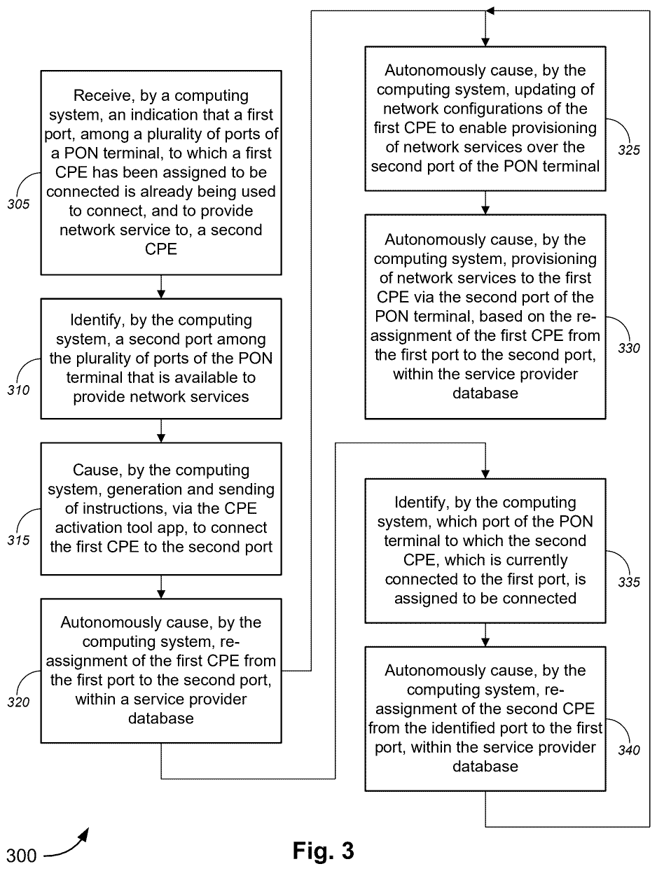

In operation, computing system (including at least one of server(s) 170, management system 175, records system/database 180a and/or 180b, orchestration system 185, and/or network provisioning system 190, and/or the like) may perform methods for implementing provisioning of network services via passive optical network ports that have been incorrectly assigned or connected, as described in detail with respect to FIGS. 2A-5. For example, communication exchanges of example systems 200A and 200B as described below with respect to FIGS. 2A and 2B, and example methods 300, 400, and 500 as described below with respect to FIGS. 3, 4, and 5 may be applied with respect to the operations of system 100 of FIG. 1.

FIG. 2A depicts an example system 200A illustrating communication exchanges when implementing provisioning of network services via passive optical network ports that have been incorrectly assigned or connected, in accordance with various embodiments. FIG. 2B depicts another example system 200B illustrating communication exchanges when implementing provisioning of network services via passive optical network ports where there has been a change in residents at a customer premises location, in accordance with various embodiments. In some embodiments, CPE 105a-105c, devices 110a-110d, OLT/MST 205, PON terminal ports 210a-210x, PON 130, network gateway 145, metro network(s) 150, LAGs 155a and 155b, routers 160a-160k, server(s) 170, management system 175, records system/database 180a/180b, orchestration system 185, framework engine 185a, action engine 185b, provisioning system 190, device(s) 230, technician device(s) 195a, and user device(s) 195c of FIGS. 2A and 2B (and their interconnections) may be similar, if not identical, to the CPE 105a-105o and 105p-105y (including ONT/RG/ONT and RG/SmartNID 105), devices 110a-110o and 110p-110y, OLT 135 and/or MSTs 120a and 120b, MST PON terminal ports 125a-125n and/or OLT PON terminal ports 140a-140m, PON 130, network gateway 145, metro network(s) 150, LAGs 155a and 155b, routers 160a-160k, server(s) 170, management system 175, records system/database 180a/180b, orchestration system 185, framework engine 185a, action engine 185b, provisioning system 190, device(s) 195, technician device(s) 195a, and user device(s) 195c, respectively, of system 100 of FIG. 1 (and their interconnections), and the description of these components of system 100 of FIG. 1 (and their interconnections) are similarly applicable to the corresponding components of FIGS. 2A and 2B (and their interconnections).

With reference to FIG. 2A, in an example, when a first CPE 105a at a first customer premises 115a is intended to be connected to OLT/MST 205 (e.g., after a customer or entity has ordered provisioning of network services via the first CPE 105a, etc.), a device(s) 230 may indicate that the first CPE 105a is assigned to Port #1 (e.g., port 210a) among PON terminal ports 210a-210x of OLT/MST 205 (e.g., as denoted in FIG. 2A by the dotted line 215a between the first CPE 105a and the first port 210a). However, when a technician attempts to connect a fiber cable, which is connected to the first CPE 105a, into Port #1, the technician might discover (from information provided by the device(s) 230, such as a technician device(s) 195a, and/or from visual inspection by the technician) that another CPE (in this case, a second CPE 105b at a second customer premises 115b) is already connected to Port #1 (as denoted in FIG. 2A by the solid line 220b between the second CPE 105b and the first port 210a), and is already providing network services to the second CPE 105b via Port #1. In some cases, the second CPE 105b may originally be assigned to Port #2 (as denoted in FIG. 2A by the dotted line 220a between the second CPE 105b and the second port 210b). The technician, who is on-site at the location of the OLT/MST 205 (e.g., at a central office, at a last-mile location, or at a neighborhood of the customer premises 115a and 115b, etc.), may send, using technician device(s) 195a, CPE or port information 240a regarding the incorrectly assigned or connected Port #1 to at least one of server(s) 170, management system 175, and/or records system/database 180a in service provider network(s) 165b. In some examples, the technician device(s) 195a may send the CPE or port information 240a over a management network channel or connection via the OLT/MST 205, the management network channel or connection being a connection that is separate from a regular data traffic connection through the metro network(s) 150 and network gateway 145. In other examples, the technician device(s) 195a may send the CPE or port information 240a via the Internet (e.g., Internet 165c), in some cases, via one or more of a wireless network connection, a cellular network connection, or a satellite network connection, and/or the like.

The technician device(s) 195a may receive information (in some examples, via a CPE activation tool app 235a running on the technician device(s) 195a, or the like) regarding the availability of another port among PON terminal ports 210a-210x (e.g., Port #2 or port 210b) to provide network services. In some instances, the technician device(s) 195a may include a light monitoring/detection device (e.g., a light meter, or the like) that is configured to detect or measure laser light being transmitted over fiber lines leading to the PON terminal ports. Alternatively or additionally, the technician device(s) 195a may (further) include a portable computing terminal, including a smart phone, a cellular phone, a laptop computer, a tablet computer, a dedicated technician portable diagnostic device, or the like. In some cases, the technician may connect the first CPE 105a to Port #2 (e.g., as denoted in FIG. 2A by the solid line 220a between the first CPE 105a and the second port 210b). In some instances, the technician device(s) 195a receives instructions and/or a guide for connecting the first CPE 105a to the second port 210b, the instructions and/or guide being generated and sent by a computing system (e.g., by orchestration system 185, the framework engine 185a, the action engine 185b, the server(s) 170, or the management system 175, or the like).

After the first CPE 105a has been connected to the second port 210b, the first CPE 105a sends its ID (e.g., serial number, or other identifier, etc.) and/or a network service request 225a to at least one of the server(s) 170, or the management system 175, the orchestration system 185, or the network provisioning system 190, and/or the like, which, in some cases, performs a handshake operation and/or an authentication operation with the first CPE 105a. After authenticating the first CPE 105a and/or the entity/customer associated with the first CPE 105a, the at least one of the server(s) 170, or the management system 175, the orchestration system 185, or the network provisioning system 190, and/or the like, may re-assign the first CPE 105a from the first port 210a to the second port 210b within the records system/database 180a and/or 180b, and may send updated network configurations 245a to the first CPE 105a to enable provisioning of network services over the second port 210b. The network provisioning system 190 may subsequently provision network services to the first CPE 105a via the second port 210b, based on the re-assignment.

In another example, a first CPE 105a that has been connected to a second port 210b may send its ID (e.g., serial number, or other identifier, etc.) and/or a network service request 225a to at least one of the server(s) 170, or the management system 175, the orchestration system 185, or the network provisioning system 190, and/or the like, which, in some cases, performs a handshake operation and/or an authentication operation with the first CPE 105a. During the handshake operation and/or the authentication operation, the at least one of the server(s) 170, or the management system 175, the orchestration system 185, or the network provisioning system 190, and/or the like, may determine that the ID of the first CPE 105a is inconsistent with the ID of a second CPE 105b that is assigned to be connected to the second port 210b. The at least one of the server(s) 170, or the management system 175, the orchestration system 185, or the network provisioning system 190, and/or the like, may, however, authenticate the first CPE 105a and may verify that network services are authorized to be provisioned to the first CPE 105a over a first port 210a. In this situation, the at least one of the server(s) 170, or the management system 175, the orchestration system 185, or the network provisioning system 190, and/or the like, may re-assign the first CPE 105a from the first port 210a to the second port 210b, and may send updated network configurations 245a to the first CPE 105a to enable provisioning of network services over the second port 210b. The network provisioning system 190 may subsequently provision network services to the first CPE 105a via the second port 210b, based on the re-assignment.

Referring to FIG. 2B, when a previously resident customer/entity leaves a customer premises 115c and is no longer associated with the customer premises 115c (e.g., as denoted in FIG. 2B by the block arrow indicating movement of device(s) 110d away from customer premises 115c), the CPE 105c (e.g., ONT/RG/ONT and RG/SmartNID 105) remains at the customer premises 115c, but the records system/database 180a and/or 180b may not always have been updated with such departure. In such situations, either network services are still associated with the previously resident customer/entity or network services to the CPE 105c has been terminated after the previously resident customer/entity has left, and thus unavailable to a newly resident customer/entity in either case. When device(s) 110c, which is associated with the newly resident customer/entity, sends a request for network services over the CPE 105c that has been connected to the first port 210a, along with its ID (e.g., serial number, or other identifier, etc.), at least one of the server(s) 170, or the management system 175, the orchestration system 185, or the network provisioning system 190, and/or the like, may perform a handshake operation and/or an authentication operation with the CPE 105c. During the handshake operation and/or the authentication operation, the at least one of the server(s) 170, or the management system 175, the orchestration system 185, or the network provisioning system 190, and/or the like, may determine that the ID of the CPE 105c that has been connected to the first port 210a is assigned to the previously resident customer/entity who is no longer associated with the customer premises 115c at which the CPE 105c is located, instead of being assigned to the newly resident customer/entity who is currently associated with the customer premises 115c.

After authenticating the newly resident customer/entity and verifying that network services are authorized to be provisioned to the device(s) 110c that is located at the customer premises 115c, the at least one of the server(s) 170, or the management system 175, the orchestration system 185, or the network provisioning system 190, and/or the like, may re-assign the CPE 105c from the previously resident customer/entity to the newly resident customer/entity within the records system/database 180a and/or 180b, and may send updated network configurations 245c to the CPE 105c to enable provisioning of network services over the first port 210a. The network provisioning system 190 may subsequently provision network services to the device(s) 110c associated with the newly resident customer/entity at the customer premises 115c CPE 105c via the first port 210a, based on the re-assignment.

With reference to FIGS. 3-5, the operations of example methods 300-500 may be performed by a computing system including one of a server, a management system, an orchestration system, a framework engine, an action engine, or a network provisioning system, and/or the like (e.g., server(s) 170, management system 175, orchestration system 185, framework engine 185a, action engine 185b, or a network provisioning system 190 of FIGS. 1 and 2).

FIG. 3 depicts flow diagrams illustrating a method 300 for implementing provisioning of network services via passive optical network ports, where a port that has been assigned to one CPE is already being used to connect another CPE, in accordance with various embodiments.

In the example method 300 of FIG. 3, at operation 305, a computing system may receive an indication (e.g., CPE or port information 240a of FIG. 2A, or the like) that a first port, among a plurality of ports of a PON terminal (e.g., a port among the plurality of ports 140a-140m of OLT 135 or a port among the plurality of ports 125a-125n of MST 120a or 120b of FIG. 1, or a port among the plurality of ports 210a-210x of OLT/MST 205 of FIG. 2A, or the like), to which a first CPE (e.g., CPE 105a of FIG. 2A, or the like) has been assigned to be connected is already being used to connect, and to provide network service to, a second CPE (e.g., CPE 105b of FIG. 2A, or the like). In examples, the first CPE is located at a first customer premises location (e.g., customer premises location 115a of FIG. 2A, or the like) and the second CPE is located at a second customer premises location (e.g., customer premises location 115b of FIG. 2A, or the like). In some examples, each of the first CPE and the second CPE may include one of an ONT, an RG, a pair of an ONT and an RG, or a SmartNID, or the like (e.g., ONT/RG/ONT and RG/SmartNID 105 of FIG. 1, or the like). In examples, the indication that the first port to which the first CPE has been assigned to be connected is already being used to connect, and to provide network service to, the second CPE may be received from a CPE activation tool app (e.g., CPE activation tool app 235a of FIG. 2A) that is running on a device. In some instances, the device (e.g., device(s) 195a-195c and 230 of FIGS. 1 and 2A) may include one of a technician device (e.g., technician device(s) 195a of FIGS. 1 and 2A) associated with a field technician, an agent device (e.g., agent device(s) 195b of FIG. 1) associated with an agent of the service provider, or a first user device (e.g., user device(s) 195c of FIGS. 1 and 2A) associated with a first customer who is associated with the first CPE, and/or the like.

At operation 310, the computing system may identify a second port among the plurality of ports of the PON terminal that is available to provide network services. At operation 315, the computing system may cause generation and sending of instructions, via the CPE activation tool app, to connect the first CPE to the second port. At operation 320, the computing system may autonomously cause re-assignment of the first CPE from the first port to the second port, within a service provider database. At operation 325, the computing system may autonomously cause updating of network configurations of the first CPE to enable provisioning of network services over the second port of the PON terminal. At operation 330, the computing system may autonomously cause provisioning of network services to the first CPE via the second port of the PON terminal, based on the re-assignment of the first CPE from the first port to the second port, within the service provider database.

In some examples, between the processes at operations 320 and 325, method 300 may further include processes at operations 335 and 340. That is, after operation 320, the computing system may identify which port of the PON terminal to which the second CPE, which is currently connected to the first port, is assigned to be connected (at operation 335); and may autonomously cause re-assignment of the second CPE from the identified port to the first port, within the service provider database (at operation 340). Method 300 may continue onto the process at operation 325.

In an example, the computing system may be an orchestration system having a framework engine and an action engine (e.g., orchestration system 185 having a framework engine 185a and an action engine 185b of FIGS. 1, 2A, and 2B, or the like). In some cases, identifying the second port among the plurality of ports of the PON terminal that is available to provide network services (at operation 310) may include one of the framework engine or the action engine of the orchestration system identifying the second port among the plurality of ports of the PON terminal that is available to provide network services, based on analysis of CPE assignments of the plurality of ports. In some instances, autonomously causing re-assignment of the first CPE from the first port to the second port (at operation 320) may include the orchestration system autonomously sending instructions to a records system to update CPE port assignment information in the service provider database with updated information indicating re-assignment of the first CPE from the first port to the second port. In some examples, autonomously causing updating of network configurations of the first CPE to enable provisioning of network services over the second port of the PON terminal (at operation 325) may include the orchestration system autonomously causing a management system to send updated network configurations (e.g., network configurations 245a of FIG. 1) to the first CPE and to cause the first CPE to update its network configurations based on the updated network configurations. In examples, autonomously causing provisioning of network services to the first CPE via the second port (at operation 330) may include the orchestration system autonomously causing the management system to provision the network services to the first CPE via the second port of the PON terminal, based on the re-assignment of the first CPE from the first port to the second port, within the service provider database.

In another example, the computing system may be one of a management system (e.g., management system 175 of FIGS. 1, 2A, and 2B, or the like) or network provisioning system (e.g., network provisioning system 190 of FIGS. 1, 2A, and 2B, or the like). In some cases, autonomously causing re-assignment of the first CPE from the first port to the second port (at operation 320) may include the one of the management system or the network provisioning system autonomously sending instructions to a records system (e.g., records system and/or database 180a or 180b of FIGS. 1 and 2A, or the like) to update CPE port assignment information in the service provider database with updated information indicating re-assignment of the first CPE from the first port to the second port. In some instances, autonomously causing updating of network configurations of the first CPE to enable provisioning of network services over the second port of the PON terminal (at operation 325) may include the one of the management system or the network provisioning system autonomously sending updated network configurations to the first CPE and sending instructions to the first CPE to cause the first CPE to update its network configurations based on the updated network configurations. In some examples, autonomously causing provisioning of network services to the first CPE via the second port (at operation 330) may include the one of the management system or the network provisioning system autonomously provisioning the network services to the first CPE via the second port of the PON terminal, based on the re-assignment of the first CPE from the first port to the second port, within the service provider database.

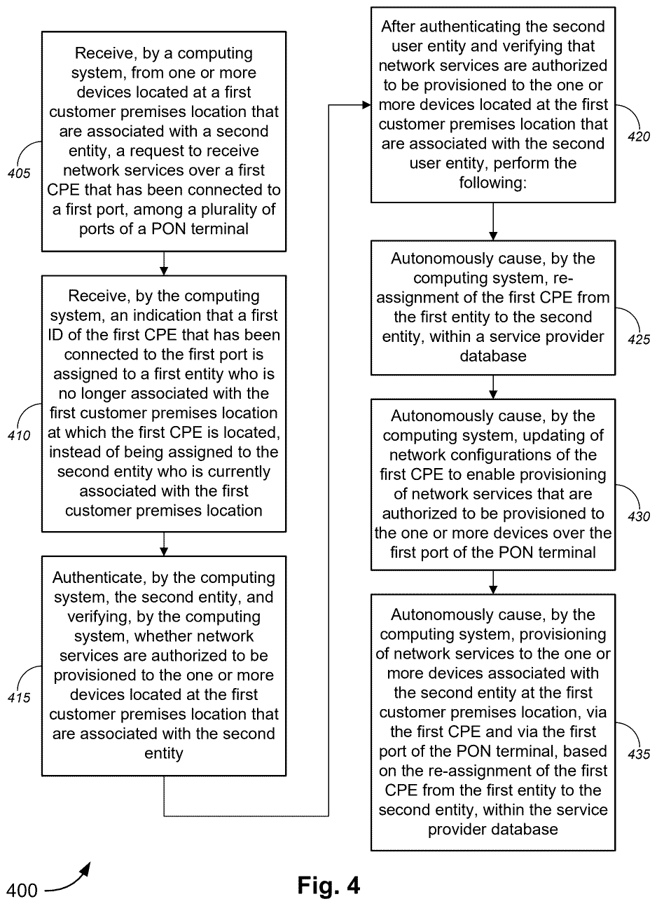

FIG. 4 depicts flow diagrams illustrating another method 400 for implementing provisioning of network services via passive optical network ports, where there has been a change in residents at a customer premises location, in accordance with various embodiments.

In the example method 400 of FIG. 4, at operation 405, a computing system may receive, from one or more devices (e.g., device(s) 110c of FIG. 2B) located at a first customer premises location (e.g., customer premises 115c of FIG. 2B) that are associated with a second entity, a request to receive network services over a first CPE (e.g., CPE 105c of FIG. 2B, or the like) that has been connected to a first port, among a plurality of ports of a PON terminal (e.g., a port among the plurality of ports 140a-140m of OLT 135 or a port among the plurality of ports 125a-125n of MST 120a or 120b of FIG. 1, or a port among the plurality of ports 210a-210x of OLT/MST 205 of FIG. 2B, or the like).

At operation 410, the computing system may receive an indication (e.g., CPE or port information 240a of FIG. 2B, or the like) that a first ID (e.g., ID 225c of FIG. 2B) of the first CPE that has been connected to the first port is assigned to a first entity who is no longer associated with the first customer premises location at which the first CPE is located, instead of being assigned to the second entity who is currently associated with the first customer premises location. In an example, the indication that the first ID of the first CPE that has been connected to the first port of the PON terminal is assigned to the first entity who is no longer associated with the first customer premises location at which the first CPE is located, instead of the second entity who is currently associated with the first customer premises location, is received from a CPE activation tool app that is running on a device (e.g., CPE activation tool app 235a running on device(s) 230 of FIG. 2B). In some examples, the device (e.g., device(s) 195a-195c and 230 of FIGS. 1 and 2B) includes one of a technician device (e.g., technician device(s) 195a of FIGS. 1 and 2B) associated with a field technician, an agent device (e.g., agent device(s) 195b of FIG. 1) associated with an agent of the service provider, or a first user device (e.g., user device(s) 195c of FIGS. 1 and 2B) associated with the second entity who is currently associated with the first CPE. In another example, the indication that the first ID of the first CPE that has been connected to the first port of the PON terminal is assigned to the first entity who is no longer associated with the first customer premises location at which the first CPE is located, instead of the second entity who is currently associated with the first customer premises location, includes an indication of termination of network services being provisioned to the first CPE under a services contract to the first entity, followed by at least one of a request for network services or a request for network connectivity being received from the one or more devices via the first CPE and via the first port.

At operation 415, the computing system may authenticate the second entity, and may verify whether network services are authorized to be provisioned to the one or more devices located at the first customer premises location that are associated with the second entity. At operation 420, after authenticating the second entity and verifying that network services are authorized to be provisioned to the one or more devices located at the first customer premises location that are associated with the second entity, the computing system may perform the following: (1) autonomously causing re-assignment of the first CPE from the first entity to the second entity, within a service provider database (at operation 425); (2) autonomously causing updating of network configurations of the first CPE to enable provisioning of network services that are authorized to be provisioned to the one or more devices over the first port of the PON terminal (at operation 430); and (3) autonomously causing provisioning of network services to the one or more devices associated with the second entity at the first customer premises location, via the first CPE and via the first port of the PON terminal, based on the re-assignment of the first CPE from the first entity to the second entity, within the service provider database (at operation 435).

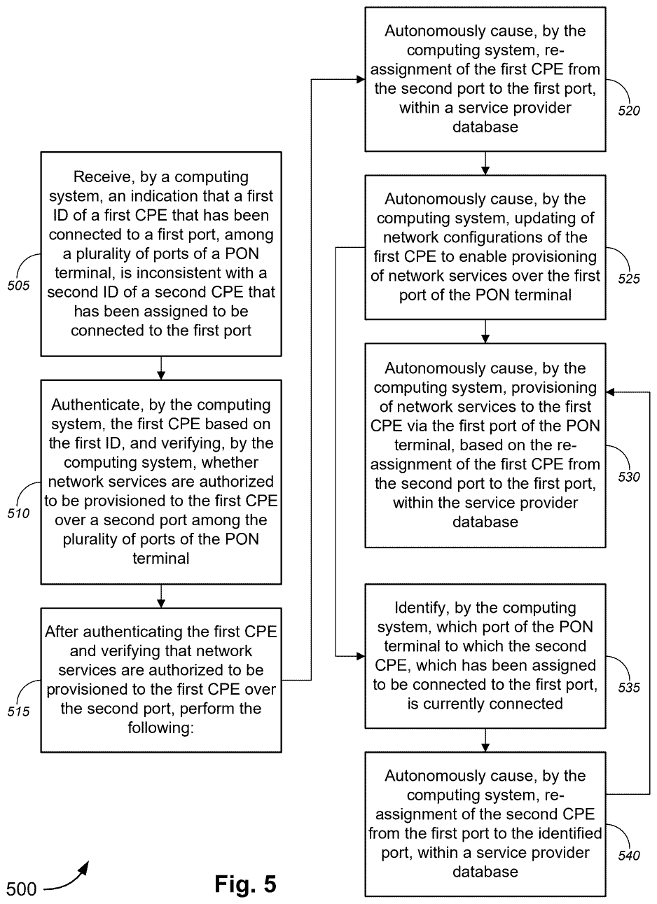

FIG. 5 depicts flow diagrams illustrating yet another method 500 for implementing provisioning of network services via passive optical network ports, where an ID of CPE that is connected to a port is inconsistent with an ID of another CPE that has been assigned to be connected to that port, in accordance with various embodiments.

With reference to FIG. 5, example method 500, at operation 505, may include a computing system receiving an indication (e.g., CPE or port information 240a of FIG. 2A, or the like) that a first ID (e.g., ID 225a of FIG. 2A) of a first CPE (e.g., CPE 105a of FIG. 2A, or the like) that has been connected to a first port, among a plurality of ports of a PON terminal (e.g., a port among the plurality of ports 140a-140m of OLT 135 or a port among the plurality of ports 125a-125n of MST 120a or 120b of FIG. 1, or a port among the plurality of ports 210a-210x of OLT/MST 205 of FIG. 2A, or the like), is inconsistent with a second ID of a second CPE (e.g., CPE 105b of FIG. 2A, or the like) that has been assigned to be connected to the first port. In some cases, the first CPE is located at a first customer premises location (e.g., customer premises location 115a of FIG. 2A, or the like). In examples, the indication that the first ID of the first CPE that has been connected to the first port of the PON terminal is inconsistent with the second ID of the second CPE that has been assigned to be connected to the first port is received from a CPE activation tool app (e.g., CPE activation tool app 235a of FIG. 2A) that is running on a device. In some instances, the device (e.g., device(s) 195a-195c and 230 of FIGS. 1 and 2A) may include one of a technician device (e.g., technician device(s) 195a of FIGS. 1 and 2A) associated with a field technician, an agent device (e.g., agent device(s) 195b of FIG. 1) associated with an agent of the service provider, or a first user device (e.g., user device(s) 195c of FIGS. 1 and 2A) associated with a first customer who is associated with the first CPE, and/or the like.

At operation 510, the computing system may authenticate the first CPE based on the first ID, and may verify whether network services are authorized to be provisioned to the first CPE over a second port among the plurality of ports of the PON terminal. At operation 515, after authenticating the first CPE and verifying that network services are authorized to be provisioned to the first CPE over the second port, the computing system may perform the following: (1) autonomously causing re-assignment of the first CPE from the second port to the first port, within a service provider database (at operation 520); (2) autonomously causing updating of network configurations of the first CPE to enable provisioning of network services over the first port of the PON terminal (at operation 525); and (3) autonomously causing provisioning of network services to the first CPE via the first port of the PON terminal, based on the re-assignment of the first CPE from the second port to the first port, within the service provider database (at operation 530).

In some examples, between the processes at operations 525 and 530, method 500 may further include processes at operations 535 and 540. That is, after operation 525, the computing system may identify which port of the PON terminal to which the second CPE, which has been assigned to be connected to the first port, is currently connected (at operation 535); and may autonomously cause re-assignment of the second CPE from the first port to the identified port, within a service provider database (at operation 540). Method 500 may continue onto the process at operation 530.

While the techniques and procedures in methods 300, 400, and 500 are depicted and/or described in a certain order for purposes of illustration, it should be appreciated that certain procedures may be reordered and/or omitted within the scope of various embodiments. Moreover, while the methods 300, 400, and 500 may be implemented by or with (and, in some cases, are described below with respect to) the systems, examples, or embodiments 100, 200A, and 200B of FIGS. 1, 2A, and 2B, respectively (or components thereof), such methods may also be implemented using any suitable hardware (or software) implementation. Similarly, while each of the systems, examples, or embodiments 100, 200A, and 200B of FIGS. 1, 2A, and 2B, respectively (or components thereof), can operate according to the methods 300, 400, and 500 (e.g., by executing instructions embodied on a computer readable medium), the systems, examples, or embodiments 100, 200A, and 200B of FIGS. 1, 2A, and 2B can each also operate according to other modes of operation and/or perform other suitable procedures.

Exemplary System and Hardware Implementation

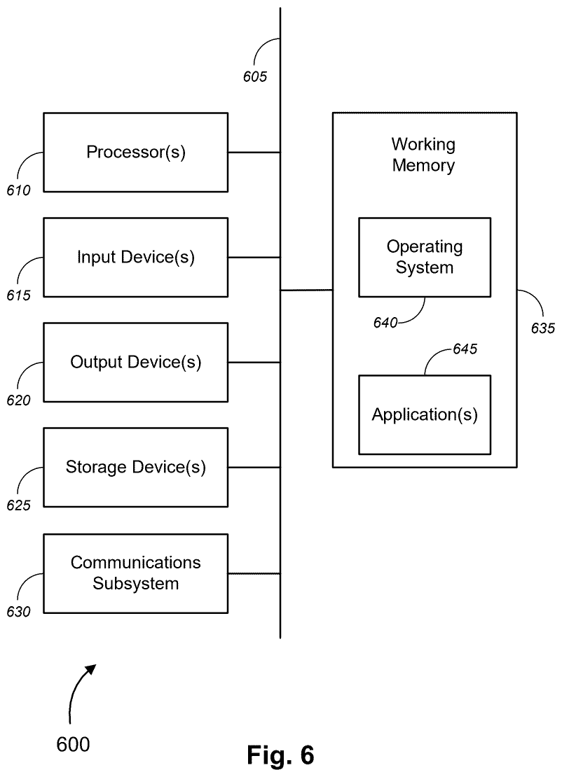

FIG. 6 is a block diagram illustrating an exemplary computer or system hardware architecture, in accordance with various embodiments. FIG. 6 provides a schematic illustration of one embodiment of a computer system 600 of the service provider system hardware that can perform the methods provided by various other embodiments, as described herein, and/or can perform the functions of computer or hardware system (i.e., CPE 105a-105o and 105p-105y, ONT/RG/ONT and RG/SmartNID 105, devices 110a-110o and 110p-110y, MSTs 120a and 120b, MST PON terminal ports 125a-125n, OLT 135, OLT PON terminal ports 140a-140m, OLT/MST 205, OLT/MST PON terminal ports 210a-210x, network gateway 145, routers 160a-160k, server(s) 170, management system 175, orchestration system 185, provisioning system 190, device(s) 195 and 230, technician device(s) 195a, agent device(s) 195b, and user device(s) 195c, etc.), as described above. It should be noted that FIG. 6 is meant only to provide a generalized illustration of various components, of which one or more (or none) of each may be utilized as appropriate. FIG. 6, therefore, broadly illustrates how individual system elements may be implemented in a relatively separated or relatively more integrated manner.

The computer or hardware system 600—which might represent an embodiment of the computer or hardware system (i.e., CPE 105a-105o and 105p-105y, ONT/RG/ONT and RG / SmartNID 105, devices 110a-110o and 110p-110y, MSTs 120a and 120b, MST PON terminal ports 125a-125n, OLT 135, OLT PON terminal ports 140a-140m, OLT/MST 205, OLT/MST PON terminal ports 210a-210x, network gateway 145, routers 160a-160k, server(s) 170, management system 175, orchestration system 185, provisioning system 190, device(s) 195 and 230, technician device(s) 195a, agent device(s) 195b, and user device(s) 195c, etc.), described above with respect to FIGS. 1-5—is shown including hardware elements that can be electrically coupled via a bus 605 (or may otherwise be in communication, as appropriate). The hardware elements may include one or more processors 610, including, without limitation, one or more general-purpose processors and/or one or more special-purpose processors (such as microprocessors, digital signal processing chips, graphics acceleration processors, and/or the like); one or more input devices 615, which can include, without limitation, a mouse, a keyboard, and/or the like; and one or more output devices 620, which can include, without limitation, a display device, a printer, and/or the like.

The computer or hardware system 600 may further include (and/or be in communication with) one or more storage devices 625, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 600 might also include a communications subsystem 630, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 630 may permit data to be exchanged with a network (such as the network described below, to name one example), with other computer or hardware systems, and/or with any other devices described herein. In many embodiments, the computer or hardware system 600 will further include a working memory 635, which can include a RAM or ROM device, as described above.

The computer or hardware system 600 also may include software elements, shown as being currently located within the working memory 635, including an operating system 640, device drivers, executable libraries, and/or other code, such as one or more application programs 645, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 600 and/or might take the form of source and/or installable code, which, upon compilation and/or installation on the computer or hardware system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 600) to perform methods in accordance with various embodiments of the invention. According to a set of embodiments, some or all of the procedures of such methods are performed by the computer or hardware system 600 in response to processor 610 executing one or more sequences of one or more instructions (which might be incorporated into the operating system 640 and/or other code, such as an application program 645) contained in the working memory 635. Such instructions may be read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 625. Volatile media includes, without limitation, dynamic memory, such as the working memory 635. In some alternative embodiments, a computer readable medium may take the form of transmission media, which includes, without limitation, coaxial cables, copper wire, and fiber optics, including the wires that include the bus 605, as well as the various components of the communication subsystem 630 (and/or the media by which the communications subsystem 630 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a computing system, an indication that a first port, among a plurality of ports of a passive optical network (“PON”) terminal, to which a first customer premises equipment (“CPE”) has been assigned to be connected is already being used to connect, and to provide network service to, a second CPE, the first CPE being located at a first customer premises location and the second CPE being located at a second customer premises location;
identifying, by the computing system, a second port among the plurality of ports of the PON terminal that is available to provide network services;
autonomously causing, by the computing system, re-assignment of the first CPE from the first port to the second port, within a service provider database;
autonomously causing, by the computing system, updating of network configurations of the first CPE to enable provisioning of network services over the second port of the PON terminal; and
autonomously causing, by the computing system, provisioning of network services to the first CPE via the second port of the PON terminal, based on the re-assignment of the first CPE from the first port to the second port, within the service provider database.

2. The method of claim 1, wherein each of the first CPE and the second CPE includes one of an optical network terminal (“ONT”), a residential gateway (“RG”), a pair of an ONT and an RG, or a combination ONT/RG network interface device (“SmartNID”).

3. The method of claim 1, wherein the PON terminal includes one of an optical line terminal (“OLT”) or a multiport service terminal (“MST”).

4. The method of claim 1, wherein the indication that the first port to which the first CPE has been assigned to be connected is already being used to connect, and to provide the network service to, the second CPE is received from a CPE activation tool software application (“app”) that is running on a device.

5. The method of claim 4, wherein the device includes one of a technician device associated with a field technician, an agent device associated with an agent of a service provider, or a first user device associated with a first customer who is associated with the first CPE.

6. The method of claim 4, further comprising:
causing, by the computing system, generation and sending of instructions, via the CPE activation tool app, to connect the first CPE to the second port.

7. The method of claim 1, wherein the computing system includes at least one of a server, a management system, an orchestration system, a framework engine, an action engine, or a network provisioning system.

8. The method of claim 1, wherein the computing system is an orchestration system having a framework engine and an action engine,
wherein identifying the second port among the plurality of ports of the PON terminal that is available to provide network services includes one of the framework engine or the action engine of the orchestration system identifying the second port among the plurality of ports of the PON terminal that is available to provide network services, based on analysis of CPE assignments of the plurality of ports,
wherein autonomously causing the re-assignment of the first CPE from the first port to the second port includes the orchestration system autonomously sending instructions to a records system to update CPE port assignment information in the service provider database with updated information indicating the re-assignment of the first CPE from the first port to the second port,
wherein autonomously causing the updating of the network configurations of the first CPE to enable provisioning of network services over the second port of the PON terminal includes the orchestration system autonomously causing a management system to send updated network configurations to the first CPE and to cause the first CPE to update its network configurations based on the updated network configurations, and
wherein autonomously causing the provisioning of network services to the first CPE via the second port includes the orchestration system autonomously causing the management system to provision the network services to the first CPE via the second port of the PON terminal, based on the re-assignment of the first CPE from the first port to the second port, within the service provider database.

9. The method of claim 1, wherein the computing system is one of a management system or a network provisioning system,
wherein autonomously causing the re-assignment of the first CPE from the first port to the second port includes the one of the management system or the network provisioning system autonomously sending instructions to a records system to update CPE port assignment information in the service provider database with updated information indicating the re-assignment of the first CPE from the first port to the second port,
wherein autonomously causing the updating of the network configurations of the first CPE to enable provisioning of network services over the second port of the PON terminal includes the one of the management system or the network provisioning system autonomously sending updated network configurations to the first CPE and sending instructions to the first CPE to cause the first CPE to update its network configurations based on the updated network configurations, and
wherein autonomously causing the provisioning of network services to the first CPE via the second port includes the one of the management system or the network provisioning system autonomously provisioning the network services to the first CPE via the second port of the PON terminal, based on the re-assignment of the first CPE from the first port to the second port, within the service provider database.

10. The method of claim 1, further comprising:
identifying, by the computing system, which port of the PON terminal to which the second CPE, which is currently connected to the first port, is assigned to be connected; and
autonomously causing, by the computing system, re-assignment of the second CPE from the identified port to the first port, within the service provider database.

11. A system, comprising:
a computing system, comprising:
a processing system; and
memory coupled to the processing system, the memory comprising computer executable instructions that, when executed by the processing system, causes the computing system to perform operations comprising:
receiving, from one or more devices located at a first customer premises location that are associated with a second entity, a request to receive network services over a first customer premises equipment (“CPE”) that has been connected to a first port, among a plurality of ports of a passive optical network (“PON”) terminal;
receiving an indication that a first identifier (“ID”) of the first CPE that has been connected to the first port is assigned to a first entity who is no longer associated with the first customer premises location at which the first CPE is located, instead of being assigned to the second entity who is currently associated with the first customer premises location;
authenticating the second entity, and verifying whether network services are authorized to be provisioned to the one or more devices located at the first customer premises location that are associated with the second entity;
after authenticating the second entity and verifying that network services are authorized to be provisioned to the one or more devices located at the first customer premises location that are associated with the second entity,
autonomously causing re-assignment of the first CPE from the first entity to the second entity, within a service provider database;
autonomously causing updating of network configurations of the first CPE to enable provisioning of network services that are authorized to be provisioned to the one or more devices over the first port of the PON terminal; and
autonomously causing provisioning of network services to the one or more devices associated with the second entity at the first customer premises location, via the first CPE and via the first port of the PON terminal, based on the re-assignment of the first CPE from the first entity to the second entity, within the service provider database.

12. The system of claim 11, wherein the first customer premises location is one of a single-family residential customer premises, a multiple dwelling unit (“MDU”) residential customer premises, a business customer premises, a corporate customer premises, an enterprise customer premises, an education facility customer premises, a medical facility customer premises, or a governmental customer premises, wherein each of the first and second entities is one of an individual, a group of individuals, a private company, a group of private companies, a public company, a group of public companies, an institution, a group of institutions, an association, a group of associations, a governmental agency, or a group of governmental agencies.

13. The system of claim 11, wherein the computing system includes at least one of a server, a management system, an orchestration system, a framework engine, an action engine, or a network provisioning system.

14. The system of claim 11, wherein the indication that the first ID of the first CPE that has been connected to the first port of the PON terminal is assigned to the first entity who is no longer associated with the first customer premises location at which the first CPE is located, instead of the second entity who is currently associated with the first customer premises location, is received from a CPE activation tool software application (“app”) that is running on a device.

15. The system of claim 14, wherein the device includes one of a technician device associated with a field technician, an agent device associated with an agent of a service provider, or a first user device associated with the second entity who is currently associated with the first CPE.

16. The system of claim 11, wherein the indication that the first ID of the first CPE that has been connected to the first port of the PON terminal is assigned to the first entity who is no longer associated with the first customer premises location at which the first CPE is located, instead of the second entity who is currently associated with the first customer premises location, includes an indication of termination of network services being provisioned to the first CPE under a services contract to the first entity, followed by at least one of a request for network services or a request for network connectivity being received from the one or more devices via the first CPE and via the first port.

17. A method, comprising:
receiving, by a computing system, an indication that a first identifier (“ID”) of a first customer premises equipment (“CPE”) that has been connected to a first port, among a plurality of ports of a passive optical network (“PON”) terminal, is inconsistent with a second ID of a second CPE that has been assigned to be connected to the first port, the first CPE being located at a first customer premises location;
authenticating, by the computing system, the first CPE based on the first ID, and verifying, by the computing system, whether network services are authorized to be provisioned to the first CPE over a second port among the plurality of ports of the PON terminal;
after authenticating the first CPE and verifying that network services are authorized to be provisioned to the first CPE over the second port,
autonomously causing, by the computing system, re-assignment of the first CPE from the second port to the first port, within a service provider database;
autonomously causing, by the computing system, updating of network configurations of the first CPE to enable provisioning of network services over the first port of the PON terminal; and
autonomously causing, by the computing system, provisioning of network services to the first CPE via the first port of the PON terminal, based on the re-assignment of the first CPE from the second port to the first port, within the service provider database.

18. The method of claim 17, wherein the indication that the first ID of the first CPE that has been connected to the first port of the PON terminal is inconsistent with the second ID of the second CPE that has been assigned to be connected to the first port is received from a CPE activation tool software application (“app”) that is running on a device.

19. The method of claim 17, further comprising:
identifying, by the computing system, which port of the PON terminal to which the second CPE, which has been assigned to be connected to the first port, is currently connected; and
autonomously causing, by the computing system, re-assignment of the second CPE from the first port to the identified port, within a service provider database.

20. The method of claim 17, wherein the CPE includes one of an optical network terminal (“ONT”), a residential gateway (“RG”), a pair of an ONT and an RG, or a combination ONT/RG network interface device (“SmartNID”), wherein the PON terminal includes one of an optical line terminal (“OLT”) or a multiport service terminal (“MST”), wherein the computing system includes at least one of a server, a management system, an orchestration system, a framework engine, an action engine, or a network provisioning system.
